(19) United States
(12) Patent Application Publication
(10) Pub. No.: US 2026/0195716 A1
(43) Pub. Date: Jul. 9, 2026

(54) SCHEDULING ELECTRONIC MEETINGS

(71) Applicant: INTERNATIONAL BUSINESS MACHINES CORPORATION, ARMONK, NY (US)

(72) Inventors: Lowell Thomason, Byron, MN (US); Mark E. Maresh, Winter Garden, FL (US); Jessica Wandrey, Kasson, MN (US); Bradley Smoley, Rochester, MN (US)

(21) Appl. No.: 19/012,126

(22) Filed: Jan. 7, 2025

(51) Int. Cl. G06Q 10/1093; G06Q 10/0631

(52) U.S. Cl. CPC G06Q 10/1093; G06Q 10/06311

(57) ABSTRACT

A method, computer program product, and computer system for scheduling electronic meetings. A time zone table including a plurality of local time zones is provided. The time zone table includes a plurality of specified dates and an offset from Coordinated Universal Time (UTC) for each of the plurality of local time zones, and for each date the offset from UTC for each time zone includes an adjustment for daylight savings time or no adjustment for daylight savings time. An electronic meeting request for a plurality of users having a plurality of electronic calendars is provided. A primary time zone and a secondary time zone are also provided. The secondary time zone is different from the primary time zone. A primary time zone start time of the meeting request and a secondary time zone start time of the meeting request are determined using the time zone table.

### BACKGROUND

The present invention relates to scheduling electronic meetings, specifically scheduling that accounts for different time zones and daylight savings time.

### SUMMARY

Embodiments of the present invention provide a method, a computer program product, and a computer system, for scheduling electronic meetings. The method includes providing a time zone table including a plurality of local time zones. The time zone table includes a plurality of specified dates and an offset from Coordinated Universal Time (UTC) for each of the plurality of local time zones. For each date of the plurality of specified dates, the offset from UTC for each of the plurality of local time zones includes an adjustment for daylight savings time or no adjustment for daylight savings time. The method also includes providing an electronic meeting request for a plurality of users having a plurality of electronic calendars, as well as providing a primary time zone selected from the plurality of local time zones and a secondary time zone selected from the plurality of local time zones. The secondary time zone is different from the primary time zone. The method also includes determining a primary time zone start time of the meeting request and a secondary time zone start time of the meeting request using the time zone table.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a block diagram of modules included in code included in the system of FIG. 1, in accordance with embodiments of the present invention.

FIG. 3 is a flow chart of an embodiment of a method for scheduling electronic meetings, in accordance with embodiments of the present invention.

FIGS. 4A-4L show an embodiment of a time zone table, in accordance with embodiments of the present invention.

### DETAILED DESCRIPTION

### Overview

Many individuals now rely on electronic calendars to organize meetings. For example, electronic calendars are often linked to personal and business email accounts and used for both personal and professional appointments, reminders, and meetings.

Electronic calendars must be kept in sync when switching between Standard Time (ST) and Daylight Saving Time (DST) and vice versa. This synchronization may become more important, but also more difficult, when individuals are in different local time zones and when those different local time zones are not on the same schedule for a switch from ST to DST and vice versa. For example, the U.S. and Europe change between DST and ST on different dates, even though they are both in the Northern Hemisphere. During the mismatched changeover times, electronic calendars may not always adjust for changes depending on what local time zones the individuals reside in as well as their individual electronic calendar/computer settings. This may cause individuals to miss meetings or other appointments.

Conventional approaches complicate these issues by using rules-based methods to determine when to adjust a calendar for DST. Such rules-based methods are usually location based, i.e., apply only to the user's current time zone. Moreover, rules-based methods are typically time based as well, i.e., apply to the user's current time and meetings that occur on the current day. Further, rules-based methods may also require the user to select whether DST and/or DST rules should be applied.

As one example, some conventional approaches may initially display a first time for a meeting and then later display a second, changed time for the same meeting due to a change from ST to DST or from DST to ST. The second, changed time for the meeting may conflict with another meeting or event. Still further, the user may not realize that the meeting time has “changed” to the second, changed meeting time until it is too late, and the meeting may be missed. Thus, even when conventional approaches try to account for ST to DST changes, they may not adjust meeting start times until/unless the respective calendars are adjusted. Further, depending on the date, some conventional approaches might not show a switched meeting time at all, leading to inconsistent/unsynchronized meeting times when respective locations do not switch from ST to DST or vice versa at the same time.

As an example, using conventional approaches, if a meeting is scheduled on a day following a switch to DST, a switched meeting time might not be shown until midnight (12:00 AM), if it is shown at all. For example, an individual in Arizona (DST not observed) may have a high likelihood of missing a meeting with an individual in Eastern Time (ET) in such situations—the individual in AZ may have a meeting time of 8:00 AM ET and 6:00 AM AZ shown on an electronic calendar when they go to bed without realizing that ET will switch to DST at midnight and thus the meeting will either be at 8:00 AM ET and 5:00 AM AZ or at 9:00 AM ET and 6:00 AM AZ. If the individual in AZ sets an alarm for 5:30 AM in order to wake up and make the 6:00 AM meeting, they may have already missed the meeting when they wake up. Alternatively, the ET individual may have another meeting at 9:00 AM ET and thus may be double-booked and unable to meet at 9:00 AM ET.

These issues can be avoided using approaches as described herein. Embodiments of the present invention provide a time zone table that includes a difference/offset between local time zones and Coordinated Universal Time (UTC) by year and day. The time zone table takes into account DST for each local time zone for each respective day. Embodiments ensure that when an individual looks at upcoming and future meetings on their electronic calendar, the individual sees actual, correct meeting start times, already adjusted for DST (if necessary), for the day of the meeting. Embodiments ensure that all individuals in a respective meeting see the actual meeting start time in their own local time zone for the day of the meeting.

Embodiments may apply to other scheduled events in addition to electronic meetings. For example, synchronized backups, updates, and other events may use embodiments as described herein. For example, in embodiments computer systems/networks may use the methods and time zone table described herein to control which time zone to use when making system updates on servers at locations around the world at a given time. For example, a company may have servers in 10 different time zones that should be updated at the same time, such as 5:00 PM ET on March 17th. During this period the U.S. is on DST and Europe is not. The methods and time zone table described herein can be used to ensure that DST does not affect the update schedule of the servers. For example, the different servers may remain synchronized even if internet connection is lost, for example, by having the time zone table and/or copies thereof on the server(s). This eliminates the requirements to access and apply DST rules-which could vary across the locations as discussed above.

In further embodiments, the time zone table may be maintained on a server, database, or other location. Various parties, computing devices, applications, programs, and the like may access the maintained time zone table for the purpose of scheduling electronic meetings and other events. For example, computing devices, applications, programs, and the like may automatically schedule meetings and set meeting times using the methods and time zone table described herein. Further, the scheduled meetings and accurate set meeting times may be automatically added to electronic calendars for the devices, applications, programs, and the like, even for future meetings.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

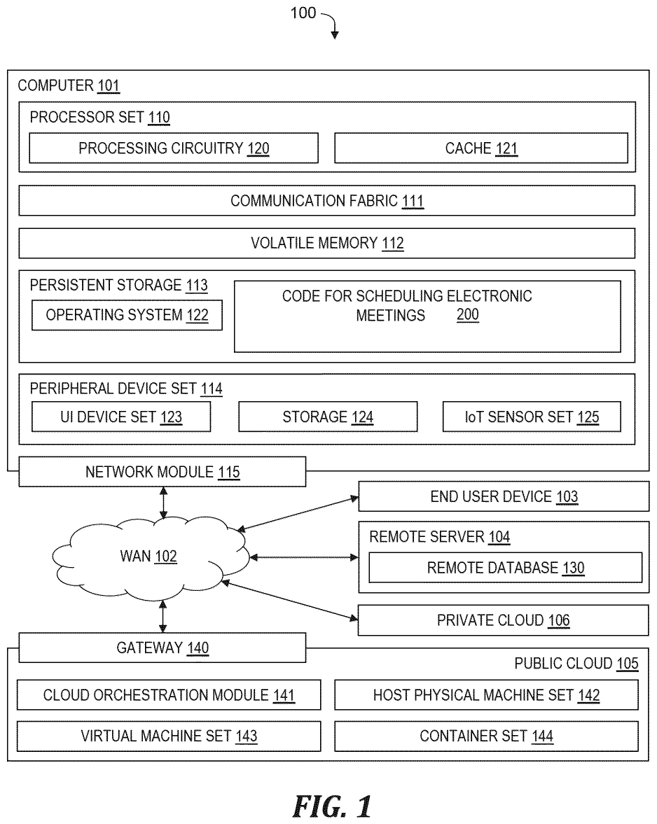

FIG. 1 depicts a computing environment which contains an example of an environment for the execution of at least some of the computer code involved in performing the inventive methods, in accordance with embodiments of the present invention. Computing environment 100 contains an example of an environment for the execution of at least some of the computer code involved in performing the inventive methods, such as code 200 for scheduling electronic meetings. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### Process and System for Scheduling Electronic Meetings

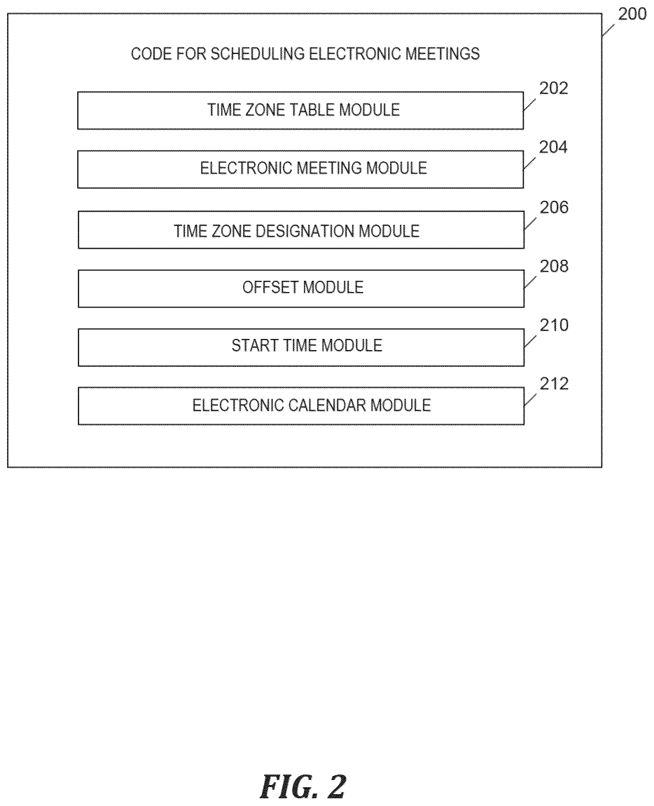

FIG. 2 is a block diagram of modules included in code included in the system of FIG. 1, in accordance with embodiments of the present invention. Code 200 includes time zone table module 202, electronic meeting module 204, time zone designation module 206, offset module 208, start time module 210, and electronic calendar module 212. The number of modules can vary and some modules may be combined with other modules or separated into two or more modules. Additional modules may also be included. In embodiments, modules may include and/or may be performed by artificial intelligence (AI), for example, one or more AI agents assigned to perform tasks. The one or more AI agents may be deployed locally as part of the computing devices, applications, programs, and the like and/or may be accessed over a network.

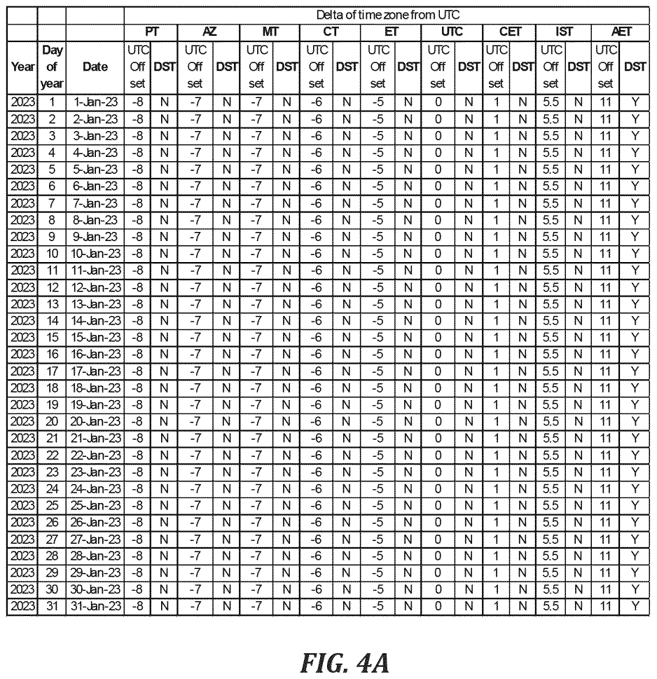

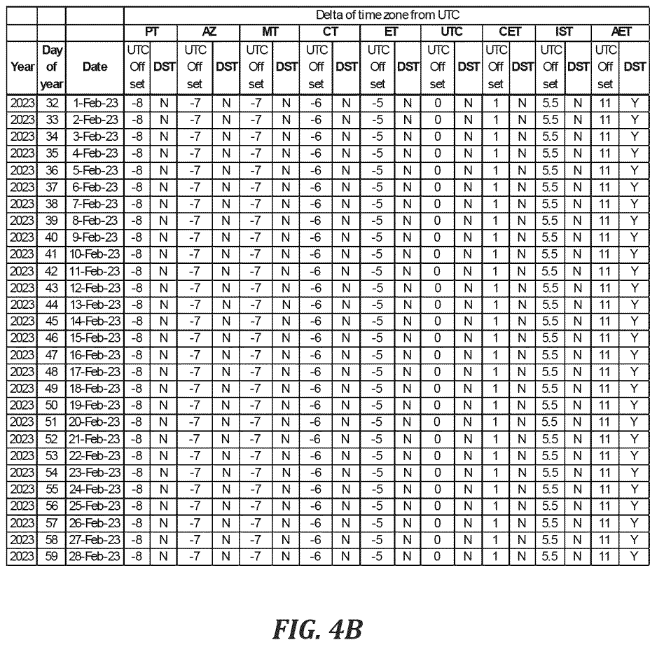

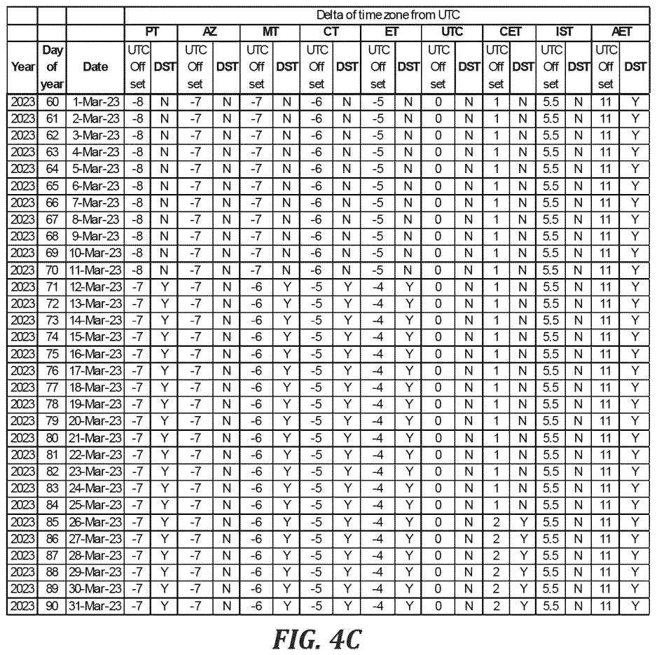

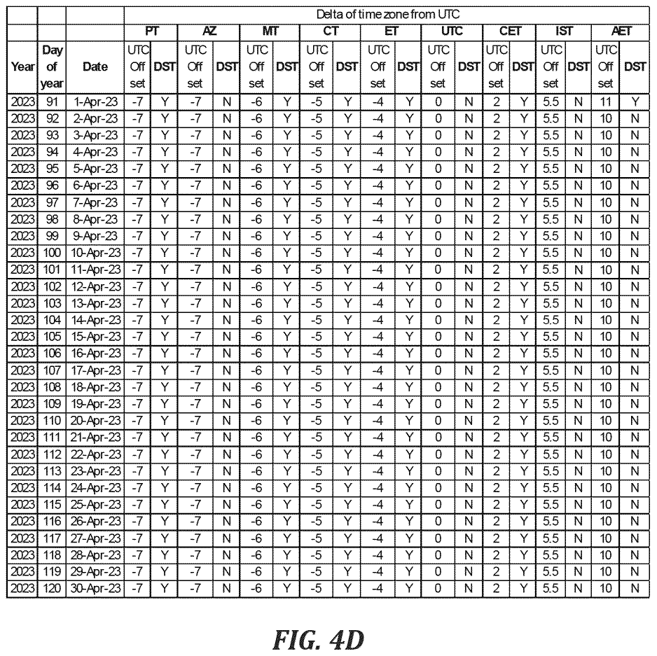

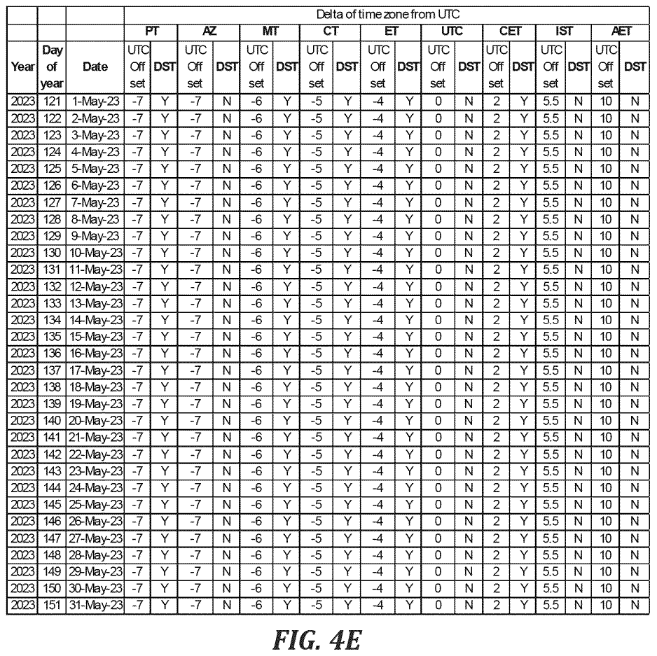

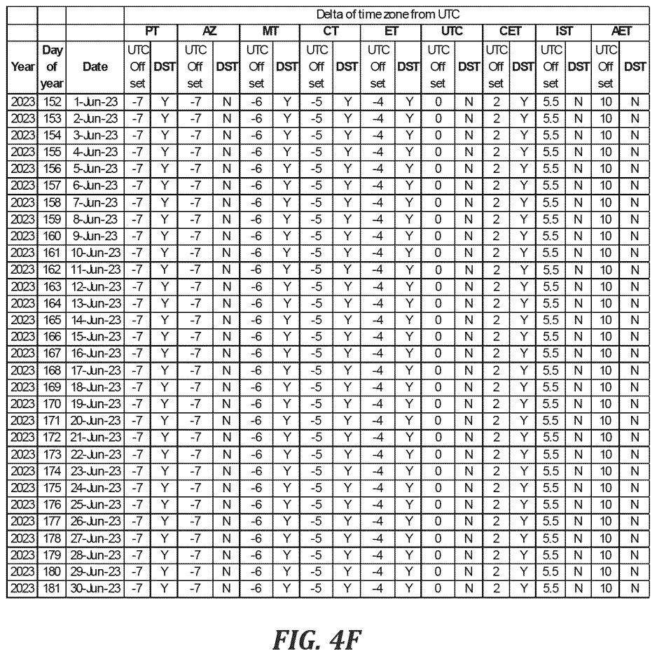

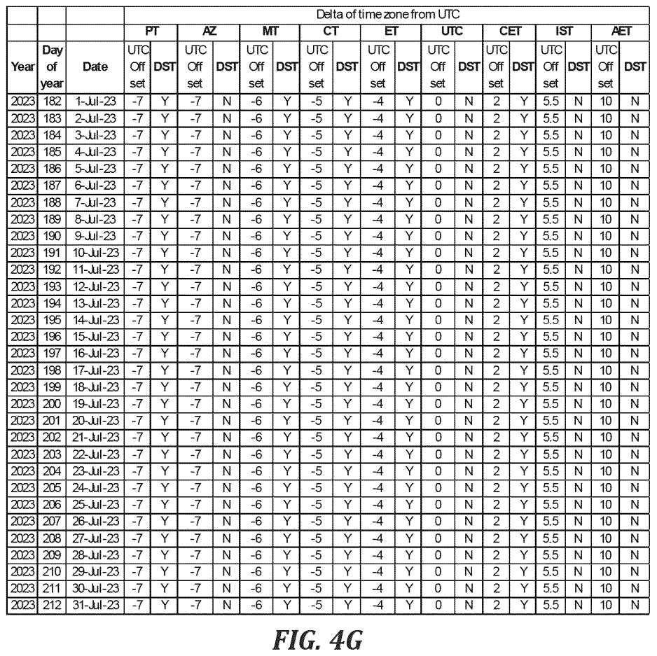

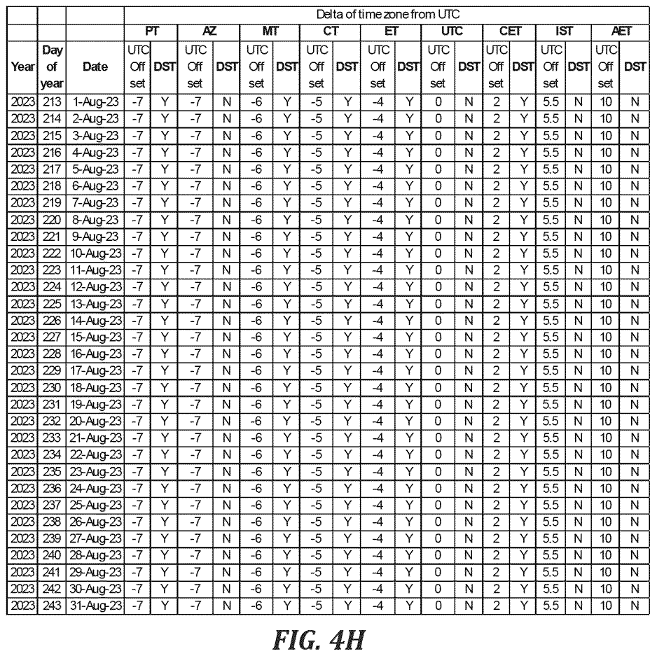

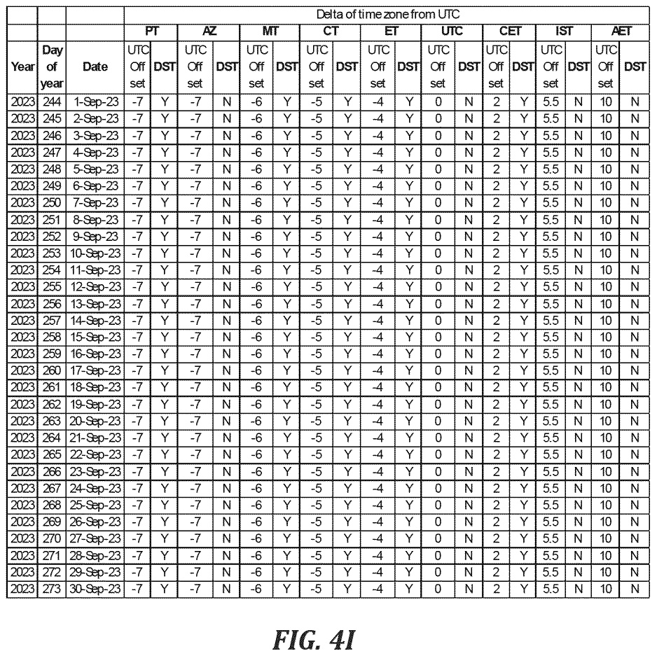

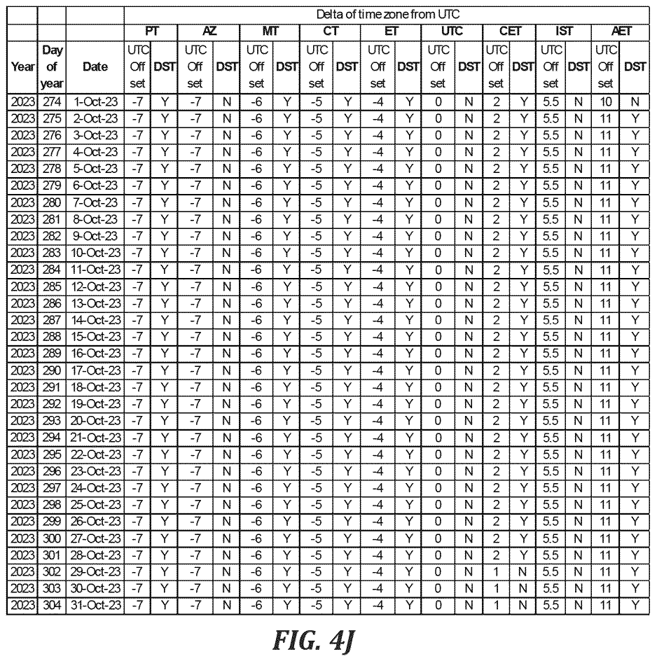

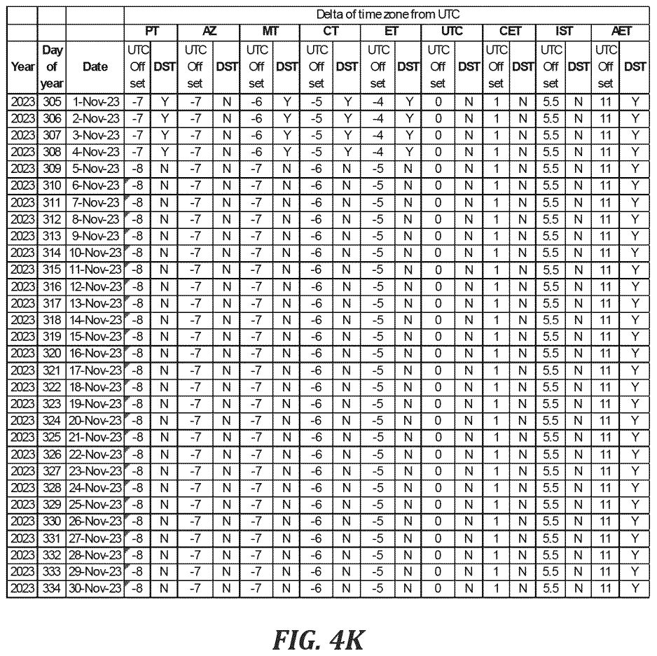

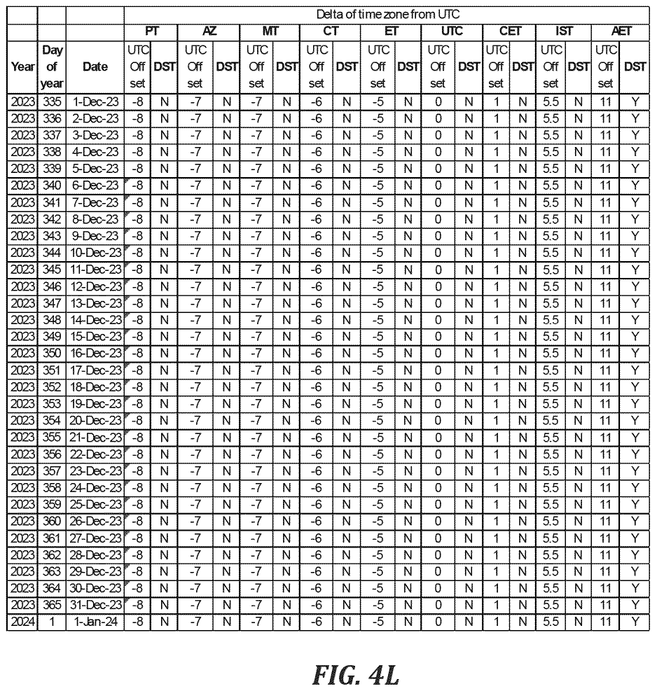

Time zone table module 202 is configured to provide a time zone table. An exemplary time zone table is shown in FIGS. 4A-4L. For example, as shown in FIGS. 4A-4L, the time zone table includes a plurality of local time zones. Referring still to FIGS. 4A-4L Pacific Time (PT), Arizona Time (AZ), Mountain Time (MT), Central Time (CT), Eastern Time (ET), UTC, Central European Time (CET), Indian Standard Time (IST), and Australia Eastern Time (AET) are shown. Still further, the time zone table includes a plurality of specified dates, for example, Jan. 1, 2023 through Jan. 1, 2024 as shown in FIGS. 4A-4L. For each day/date, an offset from UTC is included for each of the plurality of local time zones. Further, for each day/date there is an indication of whether DST applies or not. Relatedly, for each date of the plurality of specified dates, the offset from UTC for each of the plurality of local time zones includes an adjustment for DST or no adjustment for DST. In embodiments, the time zone table may include specified dates extending out as far as desired, for example, 1 year, 10 years, 100 years, etc.

Referring back to FIG. 2, time zone table module 202 may generate the time zone table and/or may retrieve the time zone table. For example, in embodiments, the time zone table may be created by the time zone table module 202 based on information retrieved from a database, information retrieved from the internet, information retrieved from a calendar, information input by a user, and/or other sources of information. In embodiments, the time zone table may be automatically generated by the time zone table module 202 using such information. Still further, in embodiments, the time zone table may be automatically generated using AI, for example, by an AI agent assigned to generate the time zone table. As an example, an AI agent may be assigned to generate the time zone table for select dates and/or for select time zones.

In some embodiments, the time zone table module 202 may retrieve the time zone table from a server, a database, a storage, a user, and the like. For example, the time zone table may be created and maintained for access by a plurality of individuals, applications, programs, and the like. In embodiments, the time zone table may be stored locally on a computing device, and the computing device may be configured to access the time zone table and apply the methods described herein for scheduling meetings. In further embodiments, the time zone table module 202 may include an AI agent assigned to retrieve the time zone table, or specific portions of the time zone table such as for specific dates and/or for specific time zones.

Electronic meeting module 204 is configured to provide an electronic meeting request. The electronic meeting request may be a calendar invitation for a meeting or another type of event, such as a scheduled backup, update, and the like. The electronic meeting request may be created by, received by, or otherwise accessed by, the electronic meeting module 204. The electronic meeting request may be for a specific day included in the plurality of specified dates in the time zone table. Further, the electronic meeting request may be for a specific time of the specific day.

In embodiments, the electronic meeting request may include multiple specific days and specific times. For example, two or more separate meetings may be included. As a further example, the electronic meeting request may be for a series of meetings, i.e., for a recurring meeting. It will be understood that various types of recurring meetings may be used. For example, a recurring meeting may occur daily, weekly, bi-weekly, monthly, quarterly, annually, and the like. In embodiments, the recurring meeting may include a plurality of meetings but may not have a uniform distribution or schedule. In embodiments, the recurring meeting may be set to start at the same time on the multiple specific days or may be set to start at different times on the multiple specific days.

Time zone designation module 206 is configured to provide a primary time zone and a secondary time zone. In embodiments, the primary time zone may be a local time zone of a computing device and/or of an individual initiating the electronic meeting request. In other embodiments, the primary time zone may be a local time zone of another computing device and/or individual, for example, a local time zone of a computing device and/or individual for whom the electronic meeting request is initiated, a local time zone of a highest ranking or most senior individual included in the electronic meeting request, a local time zone used by a majority or a numerical plurality of computing devices and/or individuals included in the electronic meeting request, and the like. The primary time zone may be determined using other methods and considerations. The secondary time zone may be a local time zone that is different from the primary time zone, for example, a local time zone of a computing device and/or an individual in a different local time zone than the primary time zone. It will be understood that more than one secondary time zone may be provided depending on the number of computing devices and/or individuals included in the electronic meeting request and their respective local time zones. The primary time zone and/or the secondary time zone may be provided by the respective computing devices and/or individual(s), may be provided by an electronic calendar associated with the respective computing devices and/or individuals(s), may be retrieved by time zone designation module 206 from other sources, and the like. It will be understood that various ways of providing the primary time zone and/or the secondary time zone are contemplated. As an example, the primary time zone and/or the secondary time zone may be determined automatically based on a current location of the respective computing devices and/or individual(s). Additionally or alternatively, the primary time zone and/or the secondary time zone may be determined automatically based on other factors, such as a home location, an expected location, a projected location, and the like.

Offset module 208 provides an offset of the secondary time zone from the primary time zone for the provided electronic meeting. In embodiments, the offset of the secondary time zone from the primary time zone is based on the time zone table. For example, offset module 208 may provide an offset of the secondary time zone from UTC based on the time zone table. Offset module 208 may also provide an offset of the primary time zone from UTC based on the time zone table. The offset of the secondary time zone from the primary time zone may then be provided and/or calculated based on subtracting the offset of the primary time zone from UTC from the offset of the secondary time zone from UTC. This process may also be explained using Formula 1: Delta D=Delta S−Delta P, wherein Delta D is the offset of the secondary time zone from the primary time zone, Delta S is the offset of the secondary time zone from UTC, and Delta P is the offset of the primary time zone from UTC.

Start time module 210 determines a primary time zone start time and a secondary time zone start time for the electronic meeting. It will be understood that the primary time zone start time and/or the secondary time zone start time include start times for multiple specific days in embodiments. For example, in the case of a recurring meeting as discussed above, the primary time zone start time and the secondary time zone start time may be determined for each meeting, i.e., for each day of the recurring meeting. As discussed above, in embodiments the recurring meeting may be set to start at the same time on the multiple specific days or may be set to start at different times on the multiple specific days. Both the primary time zone start time and the secondary time zone start time may be determined using the time zone table discussed above. Further, the primary time zone start time and/or the secondary time zone start time may be determined using the offset of the secondary time zone from the primary time zone discussed above. For example, the primary time zone start time and/or the secondary time zone start time may be determined to reduce an effect of ST to DST or DST to ST switches on the electronic meeting and/or on the plurality of meetings of the recurring meeting. In embodiments, determining the secondary time zone start time may include adding the calculated offset of the secondary time zone from the primary time zone to the primary time zone start time of the meeting request.

For example, in embodiments the primary time zone may be determined such that the recuring meeting always starts at the same time for primary time zone, i.e., the primary time zone start time is consistent regardless of DST. The primary time zone start time may be consistent regardless of DST in either the primary time zone or the secondary time zone. Based on that primary time zone start time, the secondary time zone start time may be determined and may vary depending on the time of year, i.e., whether ST or DST is in effect for the specific day in the primary time zone and/or in the secondary time zone. Thus, in embodiments, a determined secondary time zone start time for a first meeting of the plurality of meetings may be different than a determined secondary time zone start time for a second meeting of the plurality of meetings due to daylight savings time in the secondary time zone and/or due to daylight savings time in the primary time zone.

In embodiments, the primary time zone start time may be provided and the secondary time zone may be determined based on the provided primary time zone start time as described above. In further embodiments, both the primary time zone start time and the secondary time zone start time may be determined by code 200 for scheduling electronic meetings. For example, code 200 for scheduling electronic meetings and/or one or more of the electronic meeting module 206, start time module 210, and electronic calendar module 212 may be configured for determining both the primary time zone start time and the secondary time zone start time. The primary time zone start time and the secondary time zone start time may be determined, for example, automatically, to avoid and/or reduce an effect of ST to DST or DST to ST switches on the electronic meeting and/or on the plurality of meetings of the recurring meeting. For example, in some embodiments code 200 for scheduling electronic meetings and/or one or more of the electronic meeting module 206, start time module 210, and electronic calendar module 212 may determine that a provided/proposed primary time zone start time is not optimal for the group of respective computing devices and/or individual(s). For example, the provided/proposed primary time zone may result in adjustments to the secondary time zone on multiple dates and/or to a secondary time zone having a plurality of different start times for different dates, for example, three or more different start times given the changes from ST to DST and vice versa. Instead, a different primary time zone start time might be more optimal to reduce the number of changes. The different primary time zone start time may be determined and/or proposed as the primary start time and/or may be applied automatically. As discussed above, in embodiments, AI and/or an AI agent may be configured for automatically determining start times and/or for proposing start times.

Electronic calendar module 212 may provide a scheduled electronic meeting including the primary time zone start time and/or the secondary time zone start time. For example, the scheduled electronic meeting may be provided to respective computing devices and/or individuals by email, calendar notification, other notifications, and the like. In embodiments, the scheduled electronic meeting may be provided directly to a respective calendar for respective computing devices and/or individuals, for example, electronic calendar module 212 may add the meeting, and the determined local time zone start times, to an electronic calendar. In further embodiments, the respective start times may be added to the respective electronic calendars automatically. It will be understood that various ways of providing the scheduled electronic meeting to respective computing devices and/or individuals are contemplated. As a further example, in embodiments, an AI agent may automatically create the scheduled electronic meeting, add the scheduled electronic meeting to one or more local calendars, invite attendees to the scheduled electronic meeting, and the like.

In embodiments, the determined secondary time zone start time for the first meeting of the plurality of meetings and the determined secondary time zone start time for the second meeting of the plurality of meetings are both added to a respective electronic calendar at substantially the same time, i.e., the secondary start times are created and provided to the computing device and/or individual for multiple future meetings. Again, the determined secondary time zone start times may be added automatically, even for future meetings and even for future meetings where the secondary time zone start times are different. Thus, the computing device and/or individual is provided with accurate start times for future meetings and subsequent switches/adjustments are avoided.

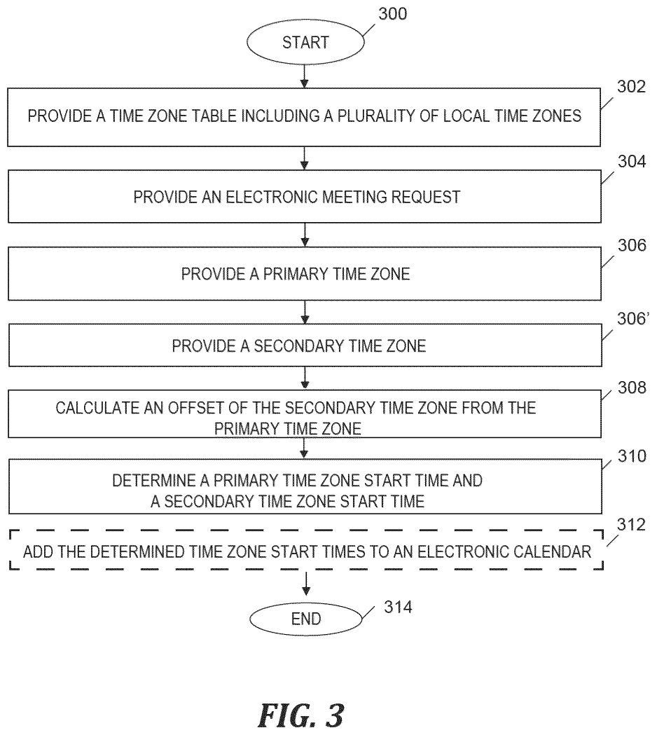

In addition to the foregoing, functionality of the various modules included in code 200 is discussed in additional detail with respect to FIG. 3, below. As discussed above, the functionality or portions thereof may be performed automatically by computing devices, applications, programs, and the like to automatically schedule meetings, set meeting times, and add meeting times to electronic calendars. Still further, the functionality or portions thereof may be performed automatically using AI and/or AI agents to schedule meetings, set meeting times, and add meeting times to electronic calendars.

FIG. 3 is a flow chart of an embodiment of a method for scheduling electronic meetings, in accordance with embodiments of the present invention. The process of FIG. 3 begins at a start node 300.

In step 302, a time zone table is provided, for example, a time zone table such as the time zone table of FIGS. 4A-4L. For example, the time zone table may be provided by time zone table module 202 (see FIG. 2).

In step 304, an electronic meeting request is provided, for example a calendar invitation for a meeting or other type of event as discussed above. For example, the electronic meeting request may be provided by electronic meeting module 204 (see FIG. 2).

In step 306, a primary time zone is provided and in step 306′, a secondary time zone is provided. As discussed above, the primary time zone and the secondary time zone are each a respective local time zone of respective computing devices and/or individual(s). For example, the primary time zone and/or the secondary time zone may be provided by time zone designation module 206.

In step 308, an offset of the secondary time zone from the primary time zone is calculated and/or provided. For example, the offset of the secondary time zone from the primary time zone may be calculated and/or provided by offset module 308. As discussed above, the offset of the secondary time zone from the primary time zone is based on the time zone table. For example, the offset may be determined using methods discussed above, including, for example, Formula 1.

In step 310, a primary time zone start time and a secondary time zone start time are determined for the electronic meeting. For example, the primary time zone start time and the secondary time zone start time may be determined by the start time module 210. As discussed above, the primary time zone start time and/or the secondary time zone start time include start times for multiple specific days in embodiments, for example, different instances of a recurring meeting and may be determined using the time zone table and offset(s). In embodiments, the primary time zone start time and/or the secondary time zone start time may be determined to reduce an effect of ST to DST or DST to ST switches on the electronic meeting and/or on the plurality of meetings of the recurring meeting, for example, to ensure that the primary time zone start time remains the same throughout the year as discussed above.

The method may include optional step 312, in which the determined start times, i.e., the primary time zone start time and the secondary time zone start time are added to an electronic calendar, for example, to a plurality of electronic calendars. For example, the respective start times may be added to respective electronic calendars for the respective computing devices and/or individuals involved in the electronic meeting. As discussed above, the determined start times may be included in a scheduled electronic meeting and may be sent by email, calendar notification, other notifications, and the like, may be provided directly to a respective electronic calendar, and/or may be automatically added to the respective electronic calendar.

The depicted embodiment of the process shown in FIG. 3 ends at an end node 314. However, it will be understood that additional method steps may be included.

For example, in embodiments, code 200 for scheduling electronic meetings and/or method 300 may include changing and/or updating the time zone table and/or the recurring meeting. For example, if a meeting needs to be rescheduled, code 200 for scheduling electronic meetings and/or method 300 may adjust, update, determine again, or otherwise modify the determined start times. In embodiments, adjusting, updating, determining again, or otherwise modifying the determined start times may be performed automatically. Further, as discussed above, an AI agent may be assigned to automatically adjust, update, determine again, or otherwise modify the determined start times if the meeting needs to be rescheduled.

Still further, at times the time zone table itself may need to be changed or updated. For example, a territory or jurisdiction may change time zone policies, for example, to no longer apply DST, to begin applying DST, to adjust the dates for which DST will apply, and the like. An update or change to the time zone table may trigger automatic adjusting, updating, determining, and the like for determined primary time zone start times and/or secondary time zone start times. For example, in embodiments, an update or change to the time zone table may trigger automatic adjusting, updating, determining, and the like for the determined secondary time zone start time; thus, continuing to maintain the primary time zone start time at a consistent time. In embodiments, the primary time zone start time may be kept at a consistent time even when it is the primary time zone that updates or changes a DST policy. The automatic adjusting, updating, determining, and the like for the determined secondary time zone start time may include automatically updating a respective electronic calendar and/or automatically updating a respective start time on the respective electronic calendar as discussed above. As discussed above, an AI agent may be assigned to automatically adjust, update, determine again, or otherwise modify the determined start times.

In further embodiments, code 200 for scheduling electronic meetings and/or method 300 may include periodically changing and/or updating of the time zone table. For example, periodic refreshing, updating, and the like may be performed on the time zone table to ensure most recent information is included and to capture any changes to time zone statuses. Referring back to FIG. 2, in embodiments, the time zone table module 202 may be configured for automatically updating the time zone table based on any new and/or additional information. Further, as discussed above, an AI agent may be assigned to automatically change and/or update the time zone table as additional information becomes available.

In embodiments, changing and/or updating the time zone table and/or the recurring meeting and/or the determined start times may include providing changes and/or updates to the electronic calendars of the respective computing devices and/or individuals. For example, changes and/or updates may be provided to respective computing devices and/or individuals by email, calendar notification, other notifications, and the like, and/or may be added directly to respective calendars as discussed above. Changes or updates may be pushed to respective individuals, calendars, applications, programs, and the like. For example, such changes or updated may be automatically added to respective electronic calendars. Still further, in embodiments, an AI agent may be assigned to automatically provide or retrieve changes and/or updates.

Embodiments further include providing access to the time zone table, for example, to third party applications, programs, and the like. The time zone table may be maintained on a server, database, or other location. In embodiments, applications, programs, and the like may download, save, or otherwise use a local copy of the time zone table. The local copy may be updated periodically as described above. Various computing devices, parties, applications, programs, and the like may access the maintained time zone table for the purpose of scheduling electronic meetings and other events as discussed herein. Still further, various computing devices, parties, applications, programs, and the like, may use the time zone table, computer program products, and/or code 200 for scheduling electronic meetings as a service for determining start times of meetings scheduled and/or hosted on the various parties, applications, programs, and the like.

Computing devices, applications, programs, and the like may automatically schedule meetings and set meeting times using the methods and time zone table described herein and may automatically apply the scheduled meetings and set meeting times to electronic calendars included in the computing devices, applications, programs, and the like. Still further, in embodiments, AI agents may be employed to automatically determine and schedule meetings using the time zone table and methods described herein and automatically apply the scheduled meetings and set meeting times to electronic calendars included in the computing devices, applications, programs, and the like.

### EXAMPLES

Examples showing scheduling electronic meetings according to embodiments of the present invention are now provided.

### Example 1

In Example 1, a recurring meeting is created on Feb. 28, 2023. The recurring meeting includes computing devices and/or individuals in ET, AZ, CET, IST, and AET. The recurring meetings include meetings on Mar. 2, 2023; Mar. 17, 2023; May 15, 2023; Oct. 30, 2023; and Dec. 31, 2023. The primary time zone is provided as ET and the computing devices and/or individual(s) in ET would like an 8:00 AM meeting. This information is shown below in Table 1A:

TABLE 1A
Information

| | |
|---|---|
| Date Meeting Scheduled | 28 Feb. 2023 |
| Example Meeting Time 1 | 8:00 AM |
| Meeting Date 1 | 2 Mar. 2023 |
| Meeting Date 2 | 17 Mar. 2023 |
| Meeting Date 3 | 15 May 2023 |
| Meeting Date 4 | 30 Oct. 2023 |
| Meeting Date 5 | 31 Dec. 2023 |

Using the embodiments discussed above, for example, a computing environment such as computing environment 100 and/or code such as code 200 for scheduling electronic meetings and/or a method for scheduling electronic meetings such as method 300, a primary time zone start time (ET) and a plurality of secondary time zone start times (AZ, CET, IST, AET) may be determined. For example, in this Example 1, the primary time zone start time and the plurality of secondary time zone start times may be determined on Feb. 28, 2023 for the future dates of Mar. 2, 2023; Mar. 17, 2023; May 15, 2023; Oct. 30, 2023; and Dec. 31, 2023. The determined start times for each meeting of the plurality of meetings are shown in Tables 1.1-1.5 below.

TABLE 1.1
Mar. 2, 2023
2 Mar. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 61 | N | 0 | 08:00 | 8:00 AM |
| AZ | 2023 | 61 | N | −2 | 06:00 | 6:00 AM |
| CET | 2023 | 61 | N | 6 | 14:00 | 2:00 PM |
| IST | 2023 | 61 | N | 10.5 | 18:30 | 6:30 PM |
| AET | 2023 | 62 | Y | 16 | 00:00 | 12:00 AM |

As shown in Table 1.1, looking to Mar. 2, 2023, only AET is in DST. Using the time zone table from FIGS. 4A-4L and the methods discussed above, the offset for each of the secondary time zones (AZ, CET, IST, AET) may be determined. For example, Formula 1 from above (Delta D=Delta S-Delta P, wherein Delta D is the offset of the secondary time zone from the primary time zone, Delta S is the offset of the secondary time zone from UTC, and Delta P is the offset of the primary time zone from UTC).

Thus, for a meeting that is to be held on Mar. 2, 2023 and in which ET is the primary time zone, the secondary time zone start times are AZ—6:00 AM; CET—2:00 PM; IST—6:30 PM; and AET—12:00 AM. The determined time zone start times may be added to electronic calendars as discussed above.

TABLE 1.2
Mar. 17, 2023
17 Mar. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 76 | Y | 0 | 08:00 | 8:00 AM |
| AZ | 2023 | 76 | N | −3 | 05:00 | 5:00 AM |
| CET | 2023 | 76 | N | 5 | 13:00 | 1:00 PM |
| IST | 2023 | 76 | N | 9.5 | 17:30 | 5:30 PM |
| AET | 2023 | 77 | Y | 15 | 23:00 | 11:00 PM |

As shown in Table 1.2, looking to Mar. 17, 2023, both ET and AET are in DST. Again, the offset for each of the secondary time zones (AZ, CET, IST, AET) may be determined using the time zone table, this time including the fact that Delta P accounts for the effect of DST on the offset of the primary time zone from UTC.

Thus, for a meeting that is to be held on Mar. 17, 2023 and in which ET is the primary time zone, the secondary time zone start times are AZ—5:00 AM; CET—1:00 PM; IST—5:30 PM; and AET—11:00 PM. Thus, all of the secondary time zone start times will be adjusted due to the primary time zone now being in DST.

In conventional approaches, the changed meeting time for AZ, CET, and IST might not be shown when the meeting is created on Feb. 28, 2023. In fact, conventional approaches might not show a changed secondary time zone meeting time at all due to the fact that the DST switch occurred in ET while no switch occurred in the secondary time zones.

TABLE 1.3
May 15, 2023
15 May 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 135 | Y | 0 | 08:00 | 8:00 AM |
| AZ | 2023 | 135 | N | −3 | 05:00 | 5:00 AM |
| CET | 2023 | 135 | Y | 6 | 14:00 | 2:00 PM |
| IST | 2023 | 135 | N | 9.5 | 17:30 | 5:30 PM |
| AET | 2023 | 136 | N | 14 | 22:00 | 10:00 PM |

As shown in Table 1.3, looking to May 15, 2023, both ET and CET are in DST. AET is no longer in DST. Again, the offset for each of the secondary time zones (AZ, CET, IST, AET) may be determined using the time zone table, including the fact that Delta P accounts for the effect of DST on the offset of the primary time zone from UTC.

Thus, for a meeting that is to be held on May 15, 2023 and in which ET is the primary time zone, the secondary time zone start times are AZ—5:00 AM; CET—2:00 PM; IST—5:30 PM; and AET—10:00 PM. Of note, three different start times for the recurring meeting will have been determined for AET. Conventional approaches would have shown a single AET time for each of these days and each of the accompanying meetings when the meeting was originally scheduled on Feb. 28, 2023. Further, conventional approaches would only update the meeting time when the calendar switched to DST.

TABLE 1.4
Oct. 30, 2023
30 Oct. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 303 | Y | 0 | 08:00 | 8:00 AM |
| AZ | 2023 | 303 | N | −3 | 05:00 | 5:00 AM |
| CET | 2023 | 303 | N | 5 | 13:00 | 1:00 PM |
| IST | 2023 | 303 | N | 9.5 | 17:30 | 5:30 PM |
| AET | 2023 | 304 | Y | 15 | 23:00 | 11:00 PM |

As shown in Table 1.4, looking to Oct. 30, 2023, both ET and AET are in DST. CET is not in DST. Again, the offset for each of the secondary time zones (AZ, CET, IST, AET) may be determined using the time zone table, including the fact that Delta P accounts for the effect of DST on the offset of the primary time zone from UTC.

Thus, for a meeting that is to be held on Oct. 23, 2023 and in which ET is the primary time zone, the secondary time zone start times are AZ—5:00 AM; CET—1:00 PM; IST—5:30 PM; and AET—11:00 PM. Of note, the meeting time for AET is again different from the previous meeting.

TABLE 1.5
Dec. 31, 2023
31 Dec. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 365 | N | 0 | 08:00 | 8:00 AM |
| AZ | 2023 | 365 | N | −2 | 06:00 | 6:00 AM |
| CET | 2023 | 365 | N | 6 | 14:00 | 2:00 PM |
| IST | 2023 | 365 | N | 10.5 | 18:30 | 6:30 PM |
| AET | 2024 | 1 | Y | 16 | 00:00 | 12:00 AM |

As shown in Table 1.5, looking to Dec. 31, 2023, AET is in DST. ET is not in DST. Again, the offset for each of the secondary time zones (AZ, CET, IST, AET) may be determined using the time zone table.

Thus, for a meeting that is to be held on Dec. 31, 2023 and in which ET is the primary time zone, the secondary time zone start times are AZ—6:00 AM; CET—2:00 PM; IST—6:30 PM; and AET—12:00 PM. Of note, all of the secondary time zone start times will be different from the previous meeting due to the primary time zone not being in DST on this date.

### Example 2

Example 2 is similar to Example 1 except that the primary time zone is provided as CET and the computing devices and/or individual(s) in CET would like a 2:00 PM meeting. This information is shown below in Table 2A:

TABLE 2A
Information

| | |
|---|---|
| Date Meeting Scheduled | 28 Feb. 2023 |
| Example Meeting Time 1 | 2:00 PM |
| Meeting Date 1 | 2 Mar. 2023 |
| Meeting Date 2 | 17 Mar. 2023 |
| Meeting Date 3 | 15 May 2023 |
| Meeting Date 4 | 30 Oct. 2023 |
| Meeting Date 5 | 31 Dec. 2023 |

Again, using the embodiments discussed above, for example, a computing environment such as computing environment 100 and/or code such as code 200 for scheduling electronic meetings and/or a method for scheduling electronic meetings such as method 300, a primary time zone start time (CET) and a plurality of secondary time zone start times (ET, AZ, IST, AET) may be determined. For example, in this Example 2, the primary time zone start time and the plurality of secondary time zone start times may be determined on Feb. 28, 2023 for the future dates of Mar. 2, 2023; Mar. 17, 2023; May 15, 2023; Oct. 30, 2023; and Dec. 31, 2023. The determined start times for each meeting of the plurality of meetings are shown in Tables 2.1-2.5 below.

TABLE 2.1
Mar. 2, 2023
2 Mar. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 61 | N | −6 | 08:00 | 8:00 AM |
| AZ | 2023 | 61 | N | −8 | 06:00 | 6:00 AM |
| CET | 2023 | 61 | N | 0 | 14:00 | 2:00 PM |
| IST | 2023 | 61 | N | 4.5 | 18:30 | 6:30 PM |
| AET | 2023 | 62 | Y | 10 | 00:00 | 12:00 AM |

As shown in Table 2.1, looking to Mar. 2, 2023, only AET is in DST. Using the time zone table from FIGS. 4A-4L and the methods discussed above, the offset for each of the secondary time zones (ET, AZ, IST, AET) may be determined. For example, Formula 1 from above (Delta D=Delta S-Delta P, wherein Delta D is the offset of the secondary time zone from the primary time zone, Delta S is the offset of the secondary time zone from UTC, and Delta P is the offset of the primary time zone from UTC).

Thus, for a meeting that is to be held on Mar. 2, 2023 and in which CET is the primary time zone, the secondary time zone start times are ET—8:00 AM; AZ—6:00 AM; IST—6:30 PM; and AET—12:00 AM. As a note, these are the same times determined in Table 1.1 above. The determined time zone start times may be added to electronic calendars as discussed above.

TABLE 2.2
Mar. 17, 2023
17 Mar. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 76 | Y | −5 | 09:00 | 9:00 AM |
| AZ | 2023 | 76 | N | −8 | 06:00 | 6:00 AM |
| CET | 2023 | 76 | N | 0 | 14:00 | 2:00 PM |
| IST | 2023 | 76 | N | 4.5 | 18:30 | 6:30 PM |
| AET | 2023 | 77 | Y | 10 | 00:00 | 12:00 AM |

As shown in Table 2.2, looking to Mar. 17, 2023, both ET and AET are in DST. Again, the offset for each of the secondary time zones (ET, AZ, IST, AET) may be determined using the time zone table.

Thus, for a meeting that is to be held on Mar. 17, 2023 and in which CET is the primary time zone, the secondary time zone start times are ET—9:00 AM; AZ—6:00 AM; IST—6:30 PM; and AET—12:00 PM. Of note, in Table 2.2 only ET has a different start time for Mar. 17, 2023 compared with Mar. 2, 2023. This is in contrast to Table 1.2, in which all of the secondary time zone start times were different between the Mar. 2, 2023 meeting and the Mar. 17, 2023 meeting.

TABLE 2.3
May 15, 2023
15 May 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 135 | Y | −6 | 08:00 | 8:00 AM |
| AZ | 2023 | 135 | N | −9 | 05:00 | 5:00 AM |
| CET | 2023 | 135 | Y | 0 | 14:00 | 2:00 PM |
| IST | 2023 | 135 | N | 3.5 | 17:30 | 5:30 PM |
| AET | 2023 | 136 | N | 8 | 22:00 | 10:00 PM |

As shown in Table 2.3, looking to May 15, 2023, both ET and CET are in DST. AET is no longer in DST. Again, the offset for each of the secondary time zones (ET, AZ, IST, AET) may be determined using the time zone table, including the fact that Delta P accounts for the effect of DST on the offset of the primary time zone from UTC.

Thus, for a meeting that is to be held on May 15, 2023 and in which CET is the primary time zone, the secondary time zone start times are ET—8:00; AZ—5:00 AM; IST—5:30 PM; and AET—10:00 PM. Of note, the start time for AET is changed by two hours from the previous meeting start time. Also of note, the start time for ET is again different despite the fact that ET is still in DST.

TABLE 2.4
Oct. 30, 2023
30 Oct. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 303 | Y | −5 | 09:00 | 9:00 AM |
| AZ | 2023 | 303 | N | −8 | 06:00 | 6:00 AM |
| CET | 2023 | 303 | N | 0 | 14:00 | 2:00 PM |
| IST | 2023 | 303 | N | 4.5 | 18:30 | 6:30 PM |
| AET | 2023 | 304 | Y | 10 | 00:00 | 12:00 AM |

As shown in Table 2.4, looking to Oct. 30, 2023, both ET and AET are in DST. CET is not in DST. Again, the offset for each of the secondary time zones (ET, AZ, IST, AET) may be determined using the time zone table.

Thus, for a meeting that is to be held on Oct. 23, 2023 and in which CET is the primary time zone, the secondary time zone start times are ET—9:00 AM; AZ—6:00 AM; IST—6:30 PM; and AET—12:00 PM. Of note, the start time for AET is again changed by two hours from the previous meeting start time.

TABLE 2.5
Dec. 31, 2023
31 Dec. 2023

| | | Day | | Difference | | |
|---|---|---|---|---|---|---|
| Time | | of the | Daylight | (Delta D) | Start | Start |
| Zone | Year | year | Savings | (+/−PTZ) | (24 hr) | (12 hr) |
| ET | 2023 | 365 | N | −6 | 08:00 | 8:00 AM |
| AZ | 2023 | 365 | N | −8 | 06:00 | 6:00 AM |
| CET | 2023 | 365 | N | 0 | 14:00 | 2:00 PM |
| IST | 2023 | 365 | N | 4.5 | 18:30 | 6:30 PM |
| AET | 2024 | 1 | Y | 10 | 00:00 | 12:00 AM |

As shown in Table 2.5, looking to Dec. 31, 2023, AET is in DST. ET is not in DST. Again, the offset for each of the secondary time zones (ET, AZ, IST, AET) may be determined using the time zone table.

Thus, for a meeting that is to be held on Dec. 31, 2023 and in which CET is the primary time zone, the secondary time zone start times are ET—8:00 AM; AZ—6:00 AM; IST—6:30 PM; and AET—12:00 PM. Of note, in Table 2.5 only ET has a different start time for Dec. 31, 2023 compared with Oct. 30, 2023. This is in contrast to Table 1.5, in which all of the secondary time zone start times were different between the Oct. 30, 2023 meeting and the Dec. 31, 2023 meeting.

As shown in Examples 1 and 2, embodiments of the present invention provide improved scheduling for electronic meetings and other events. Computing devices, individuals, electronic calendars, etc. are provided with accurate start times in their respective local time zone for all meetings or events, even in the case of future and/or recurring meetings and events, and even in the case of future and/or recurring meetings and events with different start times across multiple dates. Further, embodiments of the present invention provide for accurate determination of start times across time zones and across various DST jurisdictions without relying on rules-based approaches.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for scheduling electronic meetings, comprising:
providing, by one or more processors of a computer system, a time zone table including a plurality of local time zones, wherein the time zone table includes a plurality of specified dates and an offset from Coordinated Universal Time (UTC) for each of the plurality of local time zones, and wherein, for each date of the plurality of specified dates, the offset from UTC for each of the plurality of local time zones includes an adjustment for daylight savings time or no adjustment for daylight savings time;
providing, by the one or more processors, an electronic meeting request for a plurality of users having a plurality of electronic calendars;
providing, by the one or more processors, a primary time zone selected from the plurality of local time zones;
providing, by the one or more processors, a secondary time zone selected from the plurality of local time zones, wherein the secondary time zone is different from the primary time zone; and
determining, by the one or more processors, a primary time zone start time of the meeting request and a secondary time zone start time of the meeting request using the time zone table.

2. The computer-implemented method of claim 1, further comprising:
calculating, by the one or more processors, an offset of the secondary time zone from the primary time zone using the time zone table, wherein the offset of the secondary time zone from the primary time zone is used to determine the primary time zone start time of the meeting request and/or the secondary time zone start time of the meeting request.

3. The computer-implemented method of claim 2, wherein calculating the offset of the secondary time zone from the primary time zone includes calculating an offset of the secondary time zone from UTC, calculating an offset of the primary time zone from UTC, and subtracting the calculated offset of the primary time zone from the calculated offset of the secondary time zone.

4. The computer-implemented method of claim 3, wherein determining the secondary time zone start time includes adding the calculated offset of the secondary time zone from the primary time zone to the primary time zone start time of the meeting request.

5. The computer-implemented method of claim 1, wherein the meeting request includes a plurality of recurring meetings and the determined primary time zone start time of the meeting request is consistent throughout the plurality of recurring meetings.

6. The computer-implemented method of claim 5, wherein a determined secondary time zone start time for a first meeting of the plurality of meetings is different than a determined secondary time zone start time for a second meeting of the plurality of meetings due to daylight savings time in the secondary time zone and/or due to daylight savings time in the secondary time zone.

7. The computer-implemented method of claim 6, wherein the determined secondary time zone start time for the first meeting of the plurality of meetings and the determined secondary time zone start time for the second meeting of the plurality of meetings are both added to a respective electronic calendar at substantially the same time.

8. A computer program product for scheduling electronic meetings, the computer program product comprising: one or more computer-readable storage media; and program instructions stored on the one or more storage media to perform operations comprising:
providing a time zone table including a plurality of local time zones, wherein the time zone table includes a plurality of specified dates and an offset from Coordinated Universal Time (UTC) for each of the plurality of local time zones, and wherein, for each date of the plurality of specified dates, the offset from UTC for each of the plurality of local time zones includes an adjustment for daylight savings time or no adjustment for daylight savings time;
providing an electronic meeting request for a plurality of users having a plurality of electronic calendars;
providing a primary time zone selected from the plurality of local time zones;
providing a secondary time zone selected from the plurality of local time zones, wherein the secondary time zone is different from the primary time zone; and
determining a primary time zone start time of the meeting request and a secondary time zone start time of the meeting request using the time zone table.

9. The computer program product of claim 8, wherein the operations further comprise:
calculating an offset of the secondary time zone from the primary time zone using the time zone table, wherein the offset of the secondary time zone from the primary time zone is used to determine the primary time zone start time of the meeting request and/or the secondary time zone start time of the meeting request.

10. The computer-implemented method of claim 9, wherein calculating the offset of the secondary time zone from the primary time zone includes calculating an offset of the secondary time zone from UTC, calculating an offset of the primary time zone from UTC, and subtracting the calculated offset of the primary time zone from the calculated offset of the secondary time zone.

11. The computer program product of claim 10, wherein determining the secondary time zone start time includes adding the calculated offset of the secondary time zone from the primary time zone to the primary time zone start time of the meeting request.

12. The computer program product of claim 8, wherein the meeting request includes a plurality of recurring meetings and the determined primary time zone start time of the meeting request is consistent throughout the plurality of recurring meetings.

13. The computer program product of claim 12, wherein a determined secondary time zone start time for a first meeting of the plurality of meetings is different than a determined secondary time zone start time for a second meeting of the plurality of meetings due to daylight savings time in the secondary time zone and/or due to daylight savings time in the secondary time zone.

14. The computer program product of claim 13, wherein the determined secondary time zone start time for the first meeting of the plurality of meetings and the determined secondary time zone start time for the second meeting of the plurality of meetings are both added to a respective electronic calendar at substantially the same time.

15. A computer system, comprising:
a processor set;
one or more computer-readable storage media; and
program instructions stored on the one or more storage media to cause the processor set to perform operations comprising:
providing a time zone table including a plurality of local time zones, wherein the time zone table includes a plurality of specified dates and an offset from Coordinated Universal Time (UTC) for each of the plurality of local time zones, and wherein, for each date of the plurality of specified dates, the offset from UTC for each of the plurality of local time zones includes an adjustment for daylight savings time or no adjustment for daylight savings time;
providing an electronic meeting request for a plurality of users having a plurality of electronic calendars;
providing a primary time zone selected from the plurality of local time zones;
providing a secondary time zone selected from the plurality of local time zones, wherein the secondary time zone is different from the primary time zone; and
determining a primary time zone start time of the meeting request and a secondary time zone start time of the meeting request using the time zone table.

16. The computer system of claim 15, wherein the operations further comprise:
calculating an offset of the secondary time zone from the primary time zone using the time zone table, wherein the offset of the secondary time zone from the primary time zone is used to determine the primary time zone start time of the meeting request and/or the secondary time zone start time of the meeting request.

17. The computer system of claim 16, wherein calculating the offset of the secondary time zone from the primary time zone includes calculating an offset of the secondary time zone from UTC, calculating an offset of the primary time zone from UTC, and subtracting the calculated offset of the primary time zone from the calculated offset of the secondary time zone.

18. The computer system of claim 17, wherein determining the secondary time zone start time includes adding the calculated offset of the secondary time zone from the primary time zone to the primary time zone start time of the meeting request.

19. The computer system of claim 15, wherein the meeting request includes a plurality of recurring meetings, wherein the determined primary time zone start time of the meeting request is consistent throughout the plurality of recurring meetings, and wherein a determined secondary time zone start time for a first meeting of the plurality of meetings is different than a determined secondary time zone start time for a second meeting of the plurality of meetings due to daylight savings time in the secondary time zone and/or due to daylight savings time in the secondary time zone.

20. The computer system of claim 19, wherein the determined secondary time zone start time for the first meeting of the plurality of meetings and the determined secondary time zone start time for the second meeting of the plurality of meetings are both added to a respective electronic calendar at substantially the same time.
